(19) United States
(12) Patent Application Publication
(10) Pub. No.: US 2018/0142497 A1
(43) Pub. Date: May 24, 2018

(54) DOOR LOCK

(71) Applicant: HSIANG-CHIH HUNG, NEW TAIPEI CITY (TW)

(72) Inventor: HSIANG-CHIH HUNG, NEW TAIPEI CITY (TW)

(21) Appl. No.: 15/357,189

(22) Filed: Nov. 21, 2016

(51) Int. Cl. E05B 17/00; E05B 65/00; B65D 1/34

(52) U.S. Cl. CPC E05B 17/00; B65D 1/34; E05B 65/00

(57) ABSTRACT

A door lock includes a pivot base installed on a wall locate beside an openable door leaf; a holding unit connected to the pivot base; a guiding unit installed on the wall and located at one side of the holding unit for guiding the latter to move. When the door leaf is closed, the holding unit can be turned about the pivot base and along the guiding unit to a horizontal position for a free end to interfere with the door leaf, and a user can place personal articles on the holding unit. To open the door leaf, the user first takes back the personal articles before the holding unit can be turned and unlocked. Therefore, the door lock can lock a door leaf, hold a user's personal articles when locking the door leaf, and remind the user to take back the personal articles before opening the door leaf.

### FIELD OF THE INVENTION

The present invention relates to an improved door lock, and more particularly, to a door lock that can lock a door leaf while providing a place for holding a user's personal articles.

### BACKGROUND OF THE INVENTION

To protect the user's privacy, a public toilet usually has a door equipped with a lock, which can be operated by the user to lock or unlock the toilet door. For example, the toilet door lock can include a hook mounted on a door leaf and a retaining ring mounted on an adjacent wall. By connecting the hook to the retaining ring, the door leaf can be locked to the wall to protect the user's privacy.

While the public toilet has a door equipped with a lock to protect the user's privacy, there is usually not a suitable place in the public toilet for temporarily holding the user's some personal articles, such as handbag, cell phone and/or wallet. In this case, the user might have to position the personal articles on the toilet-paper holder, the water tank, or even the ground surface. Since the personal articles are not always positioned within the user's sight, it is very possible the personal articles are carelessly left in the public toilet when the user walks out of the toilet. In this case, the user has to go back for the personal articles. However, in some worse condition, the forgotten personal articles were taken away by someone to cause a loss to the user.

It is therefore tried by the inventor to develop an improved door lock that can also be used to hold the user's personal articles and automatically remind the user to bring the personal articles with him/her before walking out of the toilet.

### SUMMARY OF THE INVENTION

A primary object of the present invention is to overcome the above problems by providing an improved door lock that provides a receiving space for holding a user's personal articles when the door lock is in a locked state, and can automatically remind the user to take back the personal articles from the receiving space before unlocking the door lock. Therefore, the door lock of the present invention has the functions of locking a door leaf, holding a user's personal articles when locking the door leaf, and reminding the user to take back the personal articles before opening the door leaf.

To achieve the above and other objects, the door lock provided according to a preferred embodiment of the present invention includes a pivot base, a holding unit and a guiding unit. The pivot base is installed on a wall, which is located at one side of an openable door leaf. The holding unit is movably connected to the pivot base and has a free end, and the free end can be moved to extend beyond a lateral side of the wall to interfere with the door leaf. The guiding unit is installed on the wall and is located at one side of the holding unit for guiding the holding unit to move when the holding unit is turned about the pivot base.

In the above door lock, the pivot base includes a base plate and a pivot shaft mounted on a surface of the base plate. The base plate is installed on the wall, and the pivot shaft has the holding unit movably connected thereto.

In the above door lock, the holding unit has at least one receiving space provided thereon.

In the above door lock, the holding unit has a guide boss provided on an inner lateral side near the free end; and the guide boss is guided by the guiding unit to move.

In the above door lock, the guiding unit includes a fixing seat and a guide track provided on a surface of the fixing seat. The fixing seat is installed on the wall; and the guide boss of the holding unit is movably engaged with the guide track.

In the above door lock, the fixing seat is in the form of a circular arc, and the guide track is also in the form of a circular arc corresponding to the fixing seat.

In summary, in the door lock of the present invention, the pivot base and the guiding unit are installed on a wall located at one side of a door leaf. When the door leaf is closed, the holding unit can be turned with the help of the pivot base and the guiding unit to a horizontal position for the free end to interfere with the door leaf, and a user can place personal articles on the holding unit. To open the door leaf, the user has to take back the personal articles placed on the holding unit before the holding unit can be turned reversely to an unlocked position. Therefore, the door lock of the present invention has the functions of locking a door leaf, holding a user's personal articles when locking the door leaf, and reminding the user to take back the personal articles before opening the door leaf.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a door lock according to a preferred embodiment of the present invention;

FIG. 2 is an exploded perspective view of the door lock of FIG. 1;

FIG. 3 shows the door lock according to the preferred embodiment of the present invention in an unlocked state; and

FIG. 4 shows the door lock according to the preferred embodiment of the present invention in a locked state.

### DETAILED DESCRIPTION OF THE PREFERRED EMBODIMENTS

The present invention will now be described with a preferred embodiment thereof and by referring to the accompanying drawings.

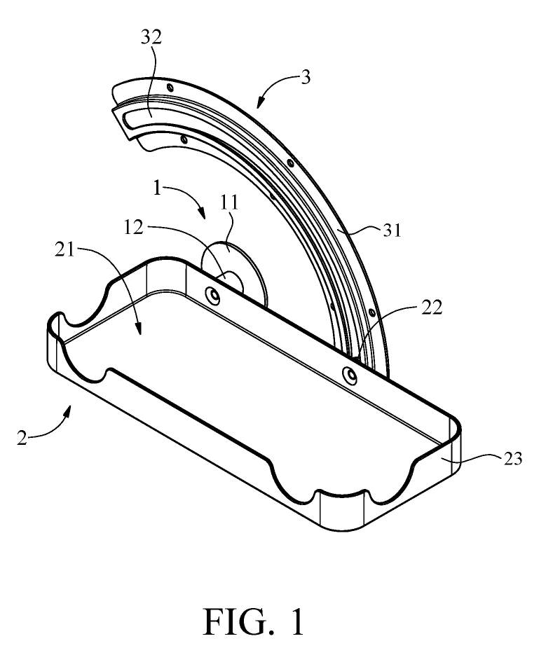

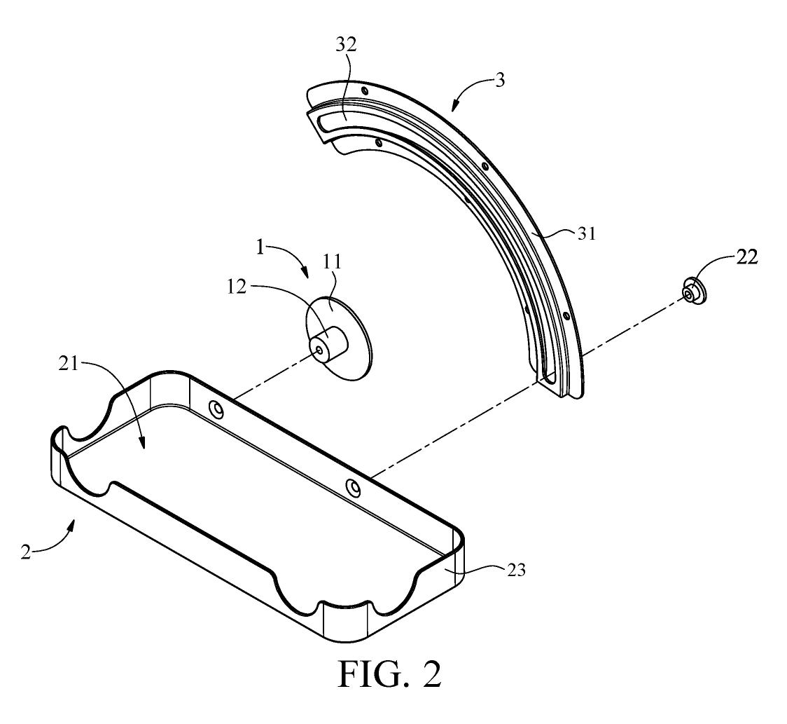

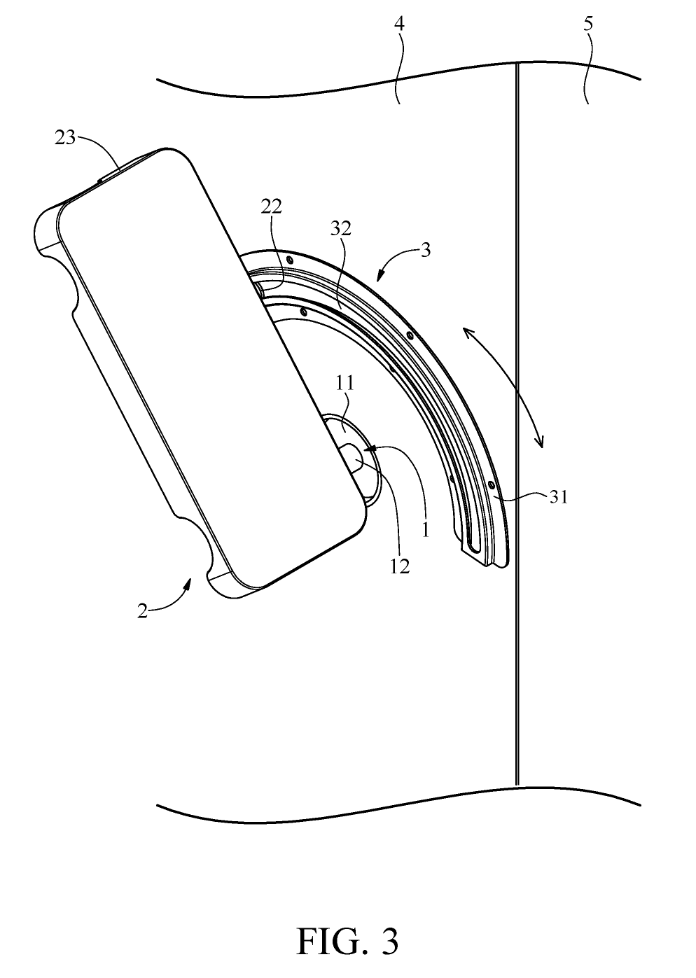

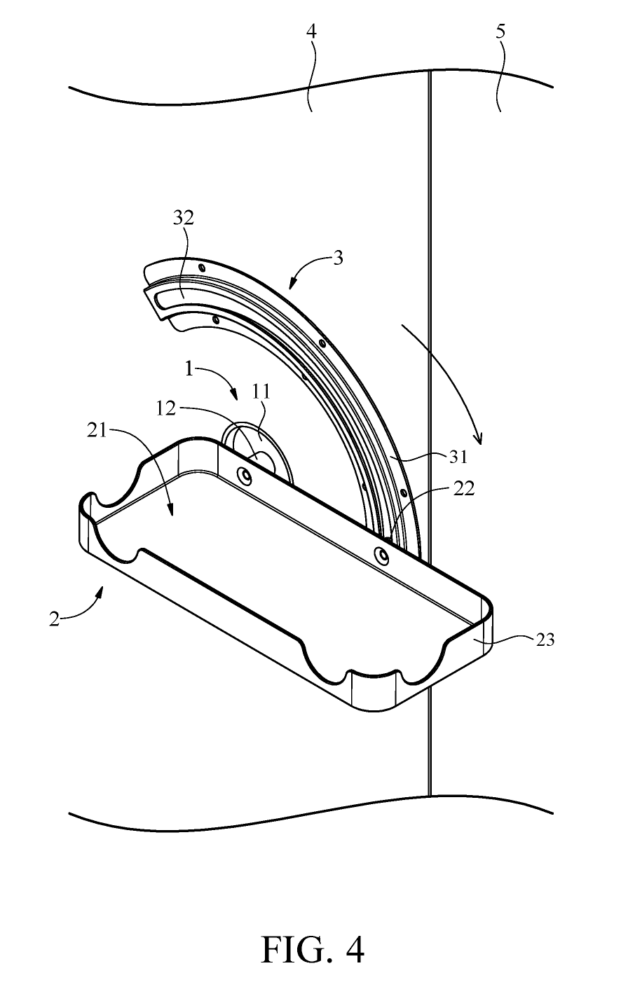

Please refer to FIGS. 1 and 2, which are assembled and exploded perspective views, respectively, of a door lock according to a preferred embodiment of the present invention; and to FIGS. 3 and 4, which show the door lock of the present invention in an unlocked and a locked state, respectively. As shown, the door lock of the present invention includes at least a pivot base 1, a holding unit 2, and a guiding unit 3.

The pivot base 1 includes a base plate 11 and a pivot shaft 12 mounted on a surface of the base plate 11.

The holding unit 2 is movably connected to the pivot base 1 and provides at least one receiving space 21 thereon. More specifically, the holding unit 2 is movably connected at an inner lateral side to the pivot shaft 12 and has a guide boss 22 provided on the same side. Further, the holding unit 2 has an end being a free end 23.

The guiding unit 3 is located at one side of the holding unit 2. The holding unit 2 is movably connected to guiding unit 3, such that the guide boss 22 of the holding unit 2 is guided by the guiding unit 3 to move. The guiding unit 3 includes a fixing seat 31 and a guide track 32 provided on a surface of the fixing seat 31. The guide boss 22 of the holding unit 2 is movably engaged with the guide track 32. The fixing seat 31 is in the form of a circular arc, and the guide track 32 is also in the form of a circular arc corresponding to the fixing seat 31.

To use the door lock of the present invention, first install the base plate 11 of the pivot base 1 and the fixing seat 31 of the guiding unit 3 on a wall 4, which is located at one side of an openable door leaf 5. Generally, the pivot base 1 is, but not necessarily, installed on an inner side of a wall 4 of a public toilet, with a proper distance between the pivot base 1 and the guiding unit 3. That is, there is a proper distance between the pivot shaft 12 and the guide boss 22, which are connected to the inner lateral side of the holding unit 2. Then, connect the holding unit 2 to the pivot base 1 and the guiding unit 3. However, in practical use of the door lock of the present invention, the pivot base 1 and the guiding unit 3 can be otherwise installed on the door leaf 5 according to actual need, so that the door lock can satisfy the requirements in different use conditions.

When the door lock of the present invention is in an unlocked state, the free end 23 of the holding unit 2 is located at a position farther away from the door leaf 5, the holding unit 2 and the receiving space 21 thereof are in an inclined position or close to an upright position without the possible to hold articles in the receiving space 21, the holding unit 2 is located with the entire inner lateral side thereof facing toward the wall 4, and the guide boss 22 is located in the guide track 32 at an end that is farther away from the door leaf 5.

To lock the door lock of the present invention, first turn the holding unit 2 about the pivot shaft 12 toward the door leaf 5, bringing the guide boss 22 of the holding unit 2 to move in the guide track 32 from the end farther away from the door leaf 5 toward another end closer to the door leaf 5. When the guide boss 22 of the holding unit 2 has reached at the other end of the guide track 32, the guide boss 22 is stopped by the guide track 32 from moving any further. At this point, the holding unit 2 has been turned to a horizontal position with the free end 23 thereof being extended beyond the lateral side of the wall 4 to interfere with the door leaf 5. That is, the door leaf 5 is stopped by the holding unit 2 from moving and is therefore in a locked state. With the holding unit 2 being located in the horizontal position, the receiving space 21 on the holding unit 2 is now facing upward and can be used to hold articles therein. Therefore, with the door lock of the present invention being set to the locked state, a user, when necessary, can conveniently place personal articles in the receiving space 21 of the holding unit 2 or hang a bags or the like on the holding unit 2. With these arrangements, the door lock of the present invention serves not only as a lock but also a device for holding a user's personal articles.

When the user has finished using the toilet and prepares to unlock the door lock, the personal articles placed in the receiving space 22 or the bags hung to the holding unit 2 must first be taken back by the user before the holding unit 2 can be reversely turned toward the wall 4 for the free end 23 of the holding unit 2 to move away from the door leaf 5. Meanwhile, the holding unit 2 and the receiving space 22 thereof will be turned to the inclined or near upright position again with the entire inner lateral side of the holding unit 2 facing toward the wall 4. At this point, the guide boss 22 in the guide track 32 is moved to the end farther away from the door leaf 5 and the free end 23 of the holding unit 2 no long interferes with the door leaf 5 to stop the door leaf 5 from being opened. When the door lock is unlocked, the door leaf 5 can be opened. Since the holding unit 2 for the door lock according to the present invention can function as a latch to lock the door leaf 5 while providing a receiving space to hold the user's personal articles, and since the holding unit 2 is located within the user's sight and must be operated by the user before the user opens the door leaf 5, the user can be automatically reminded by the door lock to take back the personal articles from the holding unit 2 when the user has finished using the toilet and prepares to unlocks the door lock. Therefore, with the door lock of the present invention, the situation of carelessly leaving personal articles in the public toilet can be effectively avoided.

The present invention has been described with a preferred embodiment thereof and it is understood that the preferred embodiment is only illustrative and not intended to limit the present invention in any way and many changes and modifications in the described embodiment can be carried out without departing from the scope and the spirit of the invention that is intended to be limited only by the appended claims.

What is claimed is:

1. A door lock, comprising:
a pivot base being installed on a wall, which is located at one side of an openable door leaf;
a holding unit being movably connected to the pivot base and having a free end; and the free end being movable to extend beyond a lateral side of the wall to interfere with the door leaf; and
a guiding unit being installed on the wall and located at one side of the holding unit for guiding the holding unit to move when the holding unit is turned about the pivot base.

2. The door lock as claimed in claim 1, wherein the pivot base includes a base plate and a pivot shaft mounted on a surface of the base plate; the base plate being installed on the wall, and the pivot shaft having the holding unit movably connected thereto.

3. The door lock as claimed in claim 1, wherein the holding unit has at least one receiving space provided thereon.

4. The door lock as claimed in claim 1, wherein the holding unit has a guide boss provided on an inner lateral side; and the guide boss being guided by the guiding unit to move.

5. The door lock as claimed in claim 4, wherein the guiding unit includes a fixing seat and a guide track provided on a surface of the fixing seat; the fixing seat being installed on the wall; and the guide boss of the holding unit being movably engaged with the guide track.

6. The door lock as claimed in claim 5, wherein the fixing seat is in the form of a circular arc; and the guide track is in the form of a circular arc corresponding to the fixing seat.
